(19) United States
(12) Patent Application Publication
(10) Pub. No.: US 2005/0285530 A1
(43) Pub. Date: Dec. 29, 2005

(54) Plasma display panel

(75) Inventors: Takashi Yamada, Yamanashi-ken (JP); Masaki Yoshinari, Yamanashi-ken (JP); Yoichi Okumura, Yamanashi-ken (JP); Tausuku Ishibashi, Yamanashi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 11/148,182

(22) Filed: Jun. 9, 2005

(30) Foreign Application Priority Data
Jun. 10, 2004 (JP) 2004-172955

(51) Int. Cl. H01J 11/02

(52) U.S. Cl. 313/586

(57) ABSTRACT

Row electrode pairs each extending in the row direction and column electrodes each extending in the column direction are provided on the front glass substrate placed opposite the back glass substrate with the discharge space in between. The row electrode pairs and the column electrodes are covered by a first dielectric layer and a second dielectric layer so as to be separated from each other. Each of the recessed trenches is formed in a portion of the first and second dielectric layers between a transparent electrode of the row electrode and the column electrode between which an address discharge is produced in the discharge cell.

### BACKGROUND OF THE INVENTION

1. Field of the Invention

This invention relates to a panel structure of a surface-discharge-type alternating-current plasma display panel.

The present application claims priority from Japanese Application No. 2004-172955, the disclosure of which is incorporated herein by reference for all purposes.

2. Description of the Related Art

Surface-discharge-type AC plasma display panels (hereinafter referred to as “PDP”) include a reflection-type PDP of a three electrode structure.

The three-electrode reflection-type PDP includes a front glass substrate and a back glass substrate which are situated opposite each other on either side of a discharge-gas-filled discharge space. The front glass substrate has the inner surface provided with a plurality of row electrode pairs and a dielectric layer covering the row electrode pairs. Each of the row electrode pairs is constituted of paired row electrodes (sustaining electrodes) extending in a row direction and arranged in parallel to each other to form a display line. The back glass substrate has an inner surface provided with a plurality of column electrodes (address electrodes) extending in the column direction. A discharge cell (unit light emitting area) is formed at each intersection of the column electrode and the row electrode pair in the discharge space, and has a red-, green- or blue-colored phosphor layer formed therein.

In the three-electrode reflection-type PDP, first, an address discharge is selectively produced between one row electrode in the row electrode pair and the column electrode to form wall charges on the dielectric layer covering the row electrode pair or to erase the wall charges formed thereon. As a result of the address discharge, the discharge cells in which the wall charges are generated on the dielectric layer (light-emitting cells) and the discharge cells in which no wall charges are generated on the dielectric layer (non-light-emitting cells) are distributed over the panel surface in accordance with the inputted video signal. After that, a sustaining discharge is initiated between the row electrodes of each row electrode pair in the light-emitting cells. The sustaining discharge causes radiation of vacuum ultraviolet light from xenon gas included in the discharge gas. The vacuum ultraviolet light excites the red, green and blue phosphor layer formed in the light-emitting cells to allow the phosphor layers to emit light for the matrix display of an image.

The conventional configuration of the three-electrode reflection-type PDP as described above requires a complicated manufacturing process for forming the electrodes on both the front and back glass substrates, and also high precision for the positional relationship between the electrodes provided on the front and back glass substrates. Such requirements give rise to the problem of an increase in manufacturing costs. The large number of components formed on each substrate has the disadvantage of further increasing the manufacturing costs.

In recent years, therefore, in order to reduce the cost and increase the high definition of the display image, a PDP having the row electrode pairs and the column electrodes formed on either the front or the back glass substrate has been suggested.

The PDP of the above type has a double-layer structure for the row electrode pairs and the column electrodes extending in the direction at right angles to the row electrode pairs in which the row electrode pairs and the column electrodes are formed on either side of the dielectric layer on one glass substrate situated opposite the other glass substrate having the phosphor layer formed thereon.

FIG. 1 is a front view illustrating the structure of a conventional PDP having both the row electrode pairs and the column electrode formed on one of the substrates.

In the PDP shown in FIG. 1, a plurality of row electrode pairs (X, Y) each constituted of the paired row electrodes X and Y extend in the row direction and are regularly arranged in the column direction on the inner surface of one of the substrates (not shown). A first dielectric layer (not shown) covers the row electrode pairs. Bodies Da of a plurality of column electrodes D extend in the column direction and are arranged at regular intervals in the row direction on the inner surface of the first dielectric layer. A second dielectric layer (not shown) covers the bodies Da of the column electrodes D.

Further, discharge portions Db of each of the column electrodes D are formed in the first dielectric layer, and each discharge portion Db is located opposite to the row electrode X or Y of the row electrode pair in one plane to enable an address discharge to be produced between the discharge portion Db and the row electrode.

The conventional PDP having such a structure is disclosed in Japanese unexamined patent publication 01-321145, for example.

However, if row electrode pairs (X, Y) and column electrodes D are provided on one of the substrates as in the case of the conventional PDP described above, the row electrode pairs (X, Y) and the column electrodes D are required to be covered with the two dielectric layers to separate them from each other. This requirement causes a rise in the interelectrode capacitance between the row electrode pair (X, Y) and the column electrode D, which in turn gives rise to the problems of a rise in the discharge starting voltage of an address discharge produced between the row electrode and the column electrode D and a reduction in the margin of the address discharge.

### SUMMARY OF THE INVENTION

The present invention has been made to solve the problems associated with the conventional plasma display panels having row electrode pairs and column electrodes formed on one of the substrates as described above.

To attain this object, a PDP according to the present invention has a pair of opposed first and second substrates placed on either side of a discharge space, in which a plurality of row electrode pairs extending in the row direction and regularly arranged in the column direction and a plurality of column electrodes extending in the column direction and regularly arranged in the row direction are provided on the first substrate and covered by dielectric layers so as to be separated from each other, and a discharge is initiated between one row electrode of the row electrode pair and the column electrode in the discharge space. The PDP is characterized by comprising recessed portions each formed in a portion of the dielectric layers between a part of the one row electrode and apart of the column electrode between which the discharge is initiated in the discharge space.

In the best mode for carrying out the present invention, a PDP has a front glass substrate and a back glass substrate placed opposite each other with the discharge space in between. A plurality of row electrode pairs each extending in the row direction are regularly arranged in the column direction on either the front glass substrate or the back glass substrate and covered by a first dielectric layer. A plurality of column electrodes each extending in the column direction are regularly arranged in the row direction on the first dielectric layer and covered by a second dielectric layer. The PDP has recessed trenches each formed in a portion of the first and second dielectric layers between the row-electrode protrusion of one of the row electrode pair and the column electrode between which an address discharge is initiated so as to intervene between the row-electrode protrusion and the column electrode.

In this PDP, in an address period for generating an image, a scan pulse is applied to one of the row electrode pair and a display data pulse corresponding to display data in a video signal is applied to the column electrode. Thereupon, an address discharge is initiated between this column electrode and the row-electrode protrusion of the row electrode in order to select the discharge cells from which visible light is emitted.

At this point, due to the recessed trench formed between the column electrode and one of the row electrode pair which are separated from each other by the dielectric layers, the amount of dielectric intervening between the column electrode and the row-electrode protrusion between which the address discharge is produced is reduced by the amount corresponding to the recessed trench. Hence, the interelectrode capacitance between the row-electrode protrusion and the column electrode is low, thus reducing the discharge starting voltage for the address discharge as compared with that in the conventional PDPs and increasing the margin of the address discharge.

These and other objects and features of the present invention will become more apparent from the following detailed description with reference to the accompanying drawings.

### BRIEF DESCRIPTION OF THE DRAWINGS

FIG. 1 is a front view illustrating the structure of a conventional PDP.

FIG. 2 is a schematic front view illustrating a first embodiment according to the present invention.

FIG. 3 is a sectional view taken along the W1-W1 line of FIG. 2.

FIG. 4 is a sectional view taken along the V1-V1 line of FIG. 2.

FIG. 5 is a sectional view taken along the V2-V2 line of FIG. 2.

FIG. 6 is a sectional view illustrating an example of modifications of the first embodiment.

FIG. 7 is a schematic sectional view illustrating a second embodiment according to the present invention.

FIG. 8 is a schematic front view illustrating a third embodiment according to the present invention.

FIG. 9 is a sectional view taken along the W2-W2 line of FIG. 8.

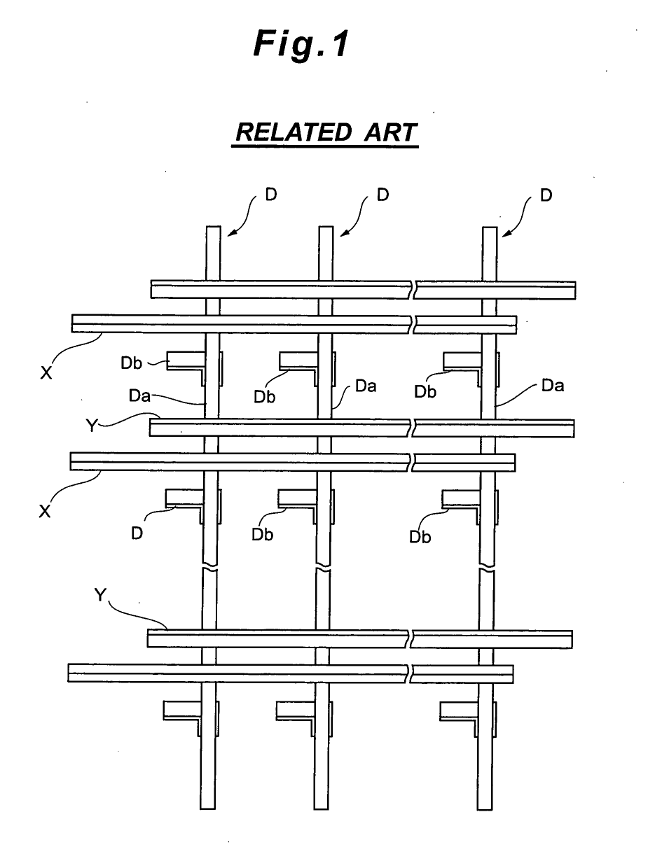

### DETAILED DESCRIPTION OF THE PREFERRED EMBODIMENTS

### First Embodiment

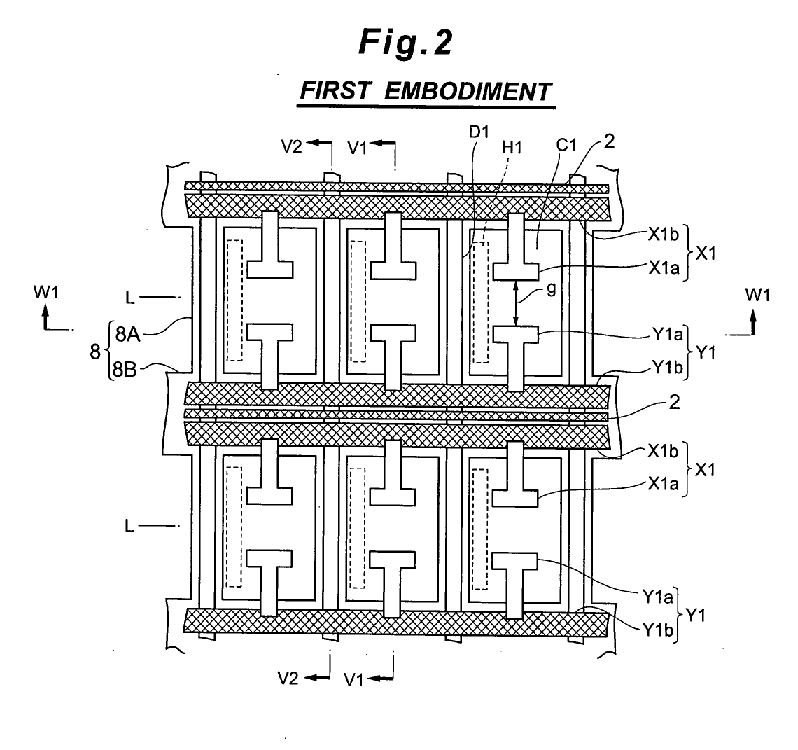

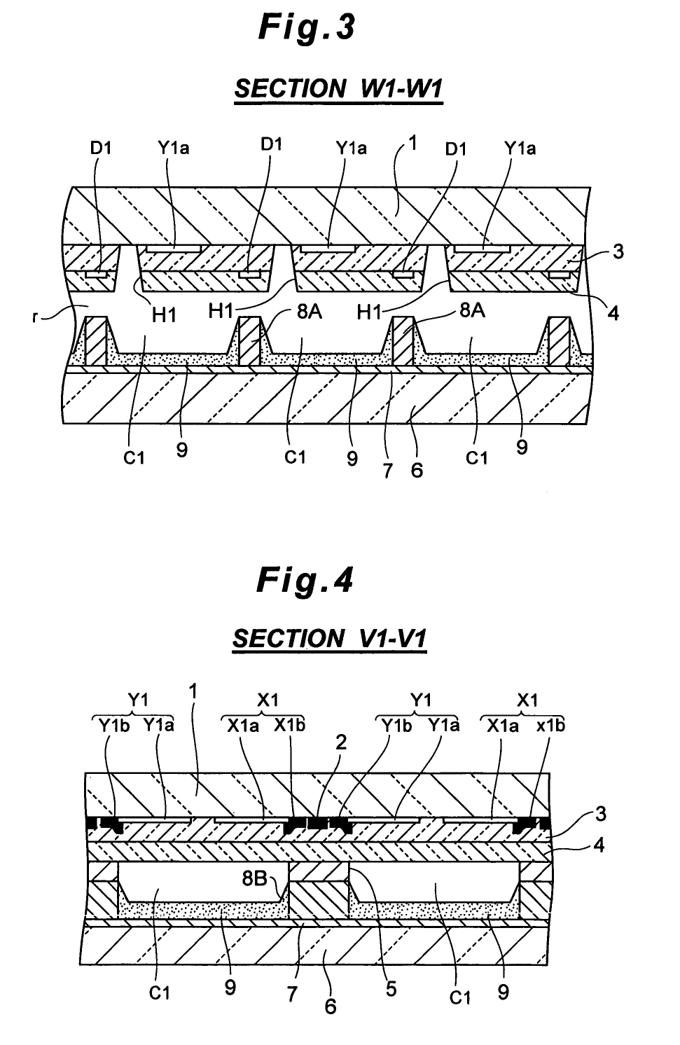

FIG. 2 to FIG. 5 illustrate a first embodiment of a plasma display panel (hereinafter referred to as “PDP”) according to the present invention. FIG. 2 is a schematic front view of the PDP in the first embodiment. FIGS. 3, 4 and 5 are sectional views respectively taken along the W1-W1 line, the V1-V1 line and the V2-V2 line of FIG. 2.

Referring to FIGS. 2 to 5, on the rear-facing surface of a front glass substrate 1 serving as a display screen, a plurality of row electrode pairs (X1, Y1) each extending in the row direction of the front glass substrate 1 (the right-left direction in FIG. 2) are arranged parallel to each other.

Each of the row electrodes X1 is constituted of T-shaped transparent electrodes X1a formed of a transparent conductive film made of ITO or the like and a bus electrode X1b formed of a black- or dark-colored metal film and extending in a bar shape in the row direction of the front glass substrate 1. The proximal end of each transparent electrode X1a (corresponding to the foot of the “T”) is connected to the bus electrode X1b.

Likewise, each of the row electrodes Y1 is constituted of T-shaped transparent electrodes Y1a formed of a transparent conductive film made of ITO or the like and a bus electrode Y1b formed of a black- or dark-colored metal film and extending in a bar shape in the row direction of the front glass substrate 1. The proximal end of each transparent electrode Y1a (corresponding to the foot of the “T”) is connected to the bus electrode Y1b.

The row electrodes X1 and Y1 are arranged in alternate positions in the column direction of the front glass substrate 1 (the vertical direction in FIG. 2). In each row electrode pair (X, Y), the transparent electrodes X1a and Y1a are regularly spaced along the associated bus electrodes X1b and Y1b and each extends out toward its counterpart in the row electrode pair, so that the wide distal ends (corresponding to the head of the “T”) of the transparent electrodes X1a and Y1a face each other with a discharge gap g having a required length in between.

Each of the row electrode pairs (X1, Y1) form a display line L of the panel.

Black- or dark-colored light absorption layers (light shield layers) 2 are formed on the rear-facing face of the front glass substrate 1. Each of the light absorption layers 2 extends in the row direction between the back-to-back bus electrodes X1b and Y1b of the row electrode pairs (X1, Y1) adjacent to each other in the column direction.

A first dielectric layer 3 is formed on the rear-facing face of the front glass substrate 1 so as to cover the row electrode pairs (X1, Y1) and the light absorption layers 2.

Column electrodes D1 each having a bar shape extending in the column direction are formed on the rear-facing face of the first dielectric layer 3. Each of the column electrodes D1 extends in a strip opposite the approximate midpoints between adjacent transparent electrodes X1a (Y1a) which are arranged at regular intervals along the associated bus electrode X1b (Y1b) of each row electrode X1 (Y1).

The column electrodes D1 are covered by a second dielectric layer 4 deposited on the rear-facing face of the first dielectric layer 3.

When the PDP is viewed from the front as illustrated in FIG. 2, recessed trenches H1 are each formed in a portion of the first dielectric layer 3 and second dielectric layer 4 between the opposed transparent electrodes X1a, Y1a in the row electrodes X1, Y1 and the column electrode D1 located on the left-hand side of these transparent electrodes X1a and Y1a. Each of the recessed trenches H1 extends in the column direction between the bus electrodes X1b and Y1b of each row electrode pair (X1, Y1).

Each of the recessed trenches H1 has a depth extending to the front glass substrate 1 from the rear-facing face of the second dielectric layer 4. The rear-facing face of the front glass substrate 1 is exposed at the end of the recessed trench Hi.

Additional dielectric layers 5 protrude from the rear-facing face of the second dielectric layer 4. Each of the additional dielectric layers 5 extends in a strip opposite the area including the back-to-back bus electrodes X1b and Y1b of the adjacent row electrode pairs (X1, Y1) and the light absorption layer 2 formed between these bus electrodes X1b and Y1b, and along the bus electrodes X1b, Y1b in the row direction.

Further, an MgO protective layer (not shown) is formed on the rear-facing faces of the second dielectric layer 4 and the additional dielectric layers 5 and the side faces of each of the recessed trenches H1.

The front glass substrate 1 is opposite a back glass substrate 6 with a discharge space in between. The back glass substrate 6 has a front-facing face facing toward the display screen covered by a dielectric layer 7.

An approximately grid-shaped partition wall unit 8 is formed on the dielectric layer 7. The partition wall unit 8 is composed of bar-shaped vertical walls 8A and bar-shaped lateral walls 8B. Each of the vertical walls 8A extends in the column direction along a strip opposite the column electrode D1 formed on the front glass substrate 1. Each of the lateral walls 8B extends in the row direction in a strip opposite the back-to-back bus electrodes X1b and Y1b of the adjacent row electrode pairs (X1, Y1) and the light absorption layer 2 formed between these bus electrodes X1b and Y1b. This partition wall unit 8 partitions the discharge space defined between the front glass substrate 1 and the back glass substrate 6 into areas each corresponding to the paired and opposed transparent electrodes X1a and Y1a in each row electrode pair (X1, Y1) to form quadrangular-shaped discharge cells C1.

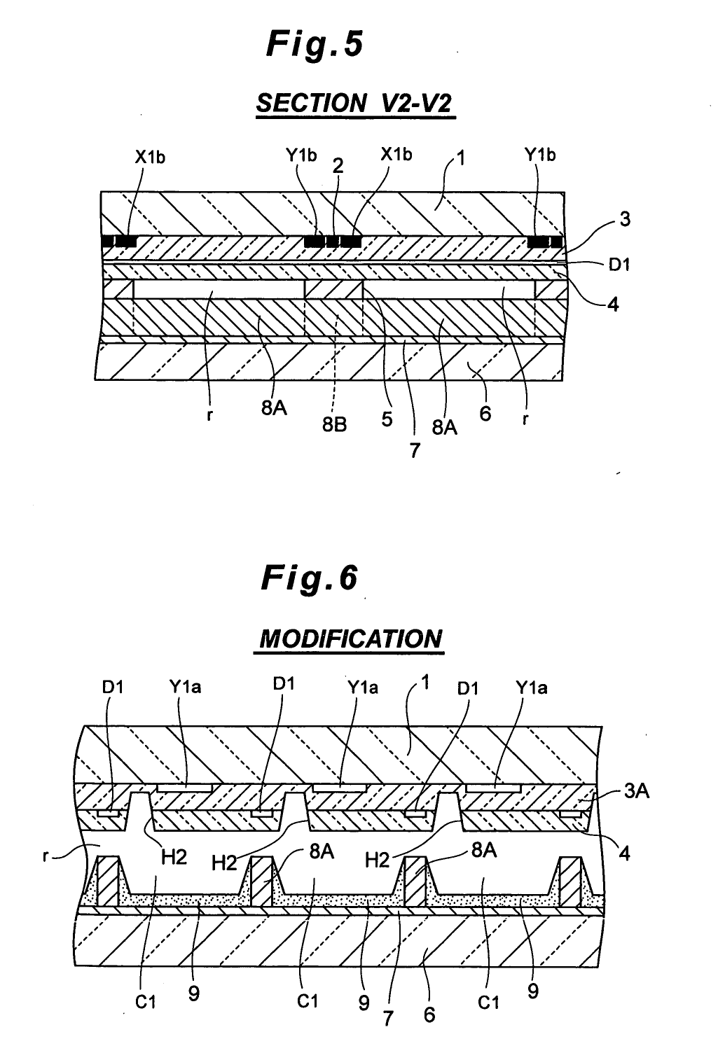

The front-facing face of each of the vertical wall 8A of the partition wall unit 8 is out of contact with the protective layer covering the additional dielectric layer 5 to create a clearance r (see FIGS. 3 and 5). The front-facing face of each of the lateral walls 8B is in contact with the protective layer covering the additional dielectric layer 5 to block the adjacent discharge cells C1 from each other in the column direction (see FIGS. 4 and 5).

A phosphor layer 9 is provided on the five faces defining each discharge cell C1: the side faces of the vertical walls 8A and the lateral walls 8B of the partition wall unit 8 and the front-facing face of the dielectric layer 7. The three primary colors, red, green and blue, are individually applied to the phosphor layers 9 so that the red, green and blue colors in the individual discharge cells C1 are arranged in order in the row direction.

The discharge space between the front glass substrate 1 and the back glass substrate 6 is filled with a discharge gas including xenon gas.

The PDP generates an image by the following steps.

In an address period after the completion of a concurrent reset period, a scan pulse is applied to the row electrode Y1, and a display data pulse corresponding to display data of a video signal is applied to the column electrode D1. Thereupon, an address discharge is selectively initiated between this column electrode D1 and the transparent electrode Y1a of the row electrode Y1 to which the scan pulse has been applied.

At this point, in FIGS. 2 and 3, due to the recessed trench H1, the interelectrode capacitance between the column electrode D1 and the transparent electrode Y1a located on the right-hand side of this column electrode D1 is lower than the interelectrode capacitance between the column electrode D1 and the transparent electrode Y1a located on the left-hand side thereof. For this reason, the address discharge is produced between the column electrode D1 and the transparent electrode Y1a located on the right-hand side of the column electrode D1.

The address discharge results in the distribution of the discharge cells C1 having the deposition of wall charge on the first dielectric layer 3 and the second dielectric layer 4 (light-emitting cells) and the discharge cells C1 having no wall charge (non-light-emitting cells) over the panel surface.

In the subsequent sustaining period, a sustaining pulse is applied alternately to the row electrodes X1 and Y1, to thereby cause a sustaining discharge between the transparent electrodes X1a and Y1a of the row electrodes X1 and Y1 opposite to each other with the discharge gap g in between in each of the light-emitting cells having the deposition of wall charge on the first and second dielectric layers 3 and 4. The sustaining discharge results in the emission of vacuum ultraviolet light from the xenon gas included in the discharge gas filling the discharge space. The vacuum ultraviolet light excites the red-, green- and blue-colored phosphor layers 9 and causes them to emit visible light, thus generating an image on matrix display.

In the foregoing structure of the PDP, the column electrodes D1, together with the row electrode pairs (X1, Y1), are formed on the front glass substrate 1. Hence, the manufacturing process is simplified, thereby significantly reducing the manufacturing costs of the PDPs.

Further, the foregoing PDP has the recessed trenches H1 each formed between the column electrode D1 and the transparent electrode Y1a of the row electrode Y1 between which the address discharge is produced. The provision of the recessed trenches H1 means a reduction of the amount of dielectric intervening between the column electrode D1 and the transparent electrode Y1a as compared with the case of conventional PDPs. The reduction of the amount of dielectric results in a reduction in the interelectrode capacitance between the column electrode D1 and the transparent electrode Y1a, which in turn offers the advantageous possibility of a reduction in the discharge starting voltage of an address discharge as compared with the case of conventional PDPs and the widening of a margin of the address discharge.

FIG. 6 is a sectional view illustrating an example of modifications of the PDP in the first embodiment when the PDP is taken along the same line as the case of FIG. 3.

The recessed trenches H1 in the PDP in the first embodiment are formed to a depth extending to the front glass substrate 1 from the rear-facing face of the second dielectric layer 4. In the PDP shown in FIG. 6, recessed trenches H2 have a depth not extending to the front glass substrate 1, and therefore the portions of the rear-facing face of the front glass substrate 1 corresponding to the recessed trenches H2 are thinly covered by the first dielectric layer 3A.

### Second Embodiment

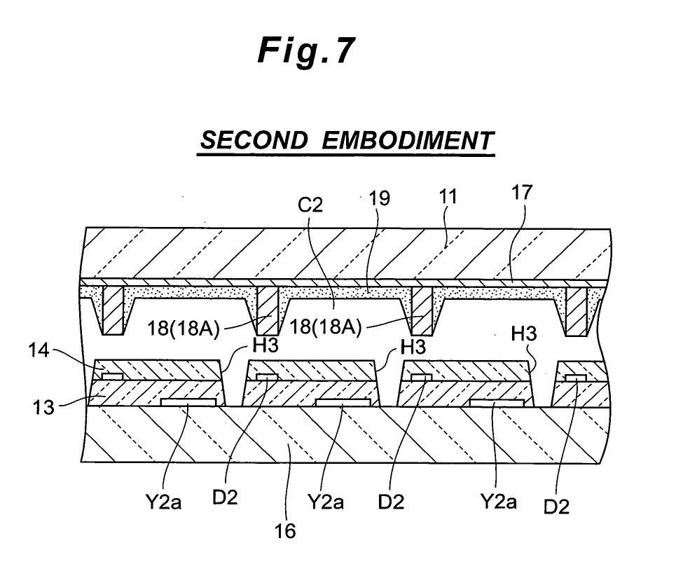

FIG. 7 is a sectional view showing the second embodiment of the PDP according to the present invention when the PDP is taken along the same line as the case of FIG. 3 in the first embodiment.

The first embodiment has described the case when the present invention is applied to a reflection-type PDP having the phosphor layers formed on the back glass substrate. The second embodiment describes the case when the present invention is applied to a transmission-type PDP having phosphor layers formed on a front glass substrate.

In a manner similar to the row electrode pairs (X1, Y1), the first dielectric layer 3, the column electrodes D1 and the second dielectric layer 4 in the first embodiment, a plurality of row electrode pairs each extending in the row direction (FIG. 7 shows only a transparent electrode Y2a of a row electrode Y2), a first dielectric layer 13 covering the row electrode pairs, a plurality of column electrodes D2 formed on the first dielectric layer 13, and a second dielectric layer 14 covering the column electrodes D2 are formed on the inner face of the back glass substrate 16 which is placed opposite the front glass substrate 11 with the discharge space in between.

In a manner similar to the first embodiment, in FIG. 7, recessed trenches H3 each extending in the column direction are formed in the first dielectric layer 13 and the second dielectric layer 14. Each of the recessed trenches H3 is disposed between the transparent electrode Y2a in each row electrode Y2 and the column electrode D2 located on the right-hand side of this transparent electrode Y2a.

In the example illustrated in FIG. 7, the recessed trench H3 has a depth extending to the back glass substrate 16 from the front-facing face of the second dielectric layer 14 such that the face of the back glass substrate 16 is exposed at the end of the recessed trench H3. However, as in the case of the example illustrated in FIG. 6, the recessed trench H3 may be formed to a depth shorter than the distance from the front-facing face of the second dielectric layer 14 to the back glass substrate 16, and consequently the portion of the back glass substrate 16 corresponding to the recessed trench H3 may be thinly covered by the first dielectric layer 13.

As in the case of the additional dielectric layers 5 in the first embodiment, additional dielectric layers (not shown) are formed on the face of the second dielectric layer 14 facing toward the front glass substrate 11. Further, an MgO protective layer (not shown) is formed on the front-facing faces of the second dielectric layer 14 and the additional dielectric layers and the side faces of each of the recessed trenches H3.

A dielectric layer 17 is formed on the rear-facing face of the front glass substrate 11. Further, an approximately grid-shaped partition wall unit 18 (FIG. 7 shows only a vertical wall 18A in the partition wall unit 18) is formed on the dielectric layer 17 as in the case of the partition wall unit 8 in the first embodiment, to define each of the discharge cells C2.

A phosphor layer 19 is provided on the five faces defining each of the discharge cells C2: the side faces of the partition wall unit 18 and the rear-facing face of the dielectric layer 17. The three primary colors, red, green and blue, are individually applied to the phosphor layers 19.

The discharge space between the front glass substrate 11 and the back glass substrate 16 is filled with a discharge gas including xenon gas.

As in the case of the PDP in the first embodiment, the PDP in the second embodiment also has the recessed trenches H3 each formed between the column electrode D2 and the transparent electrode Y2a of the row electrode Y2 between which the address discharge is produced. Due to this recessed trench H3, the amount of dielectric intervening between the column electrode D2 and the transparent electrode Y2a is reduced as compared with the case of conventional PDPs, thus reducing the interelectrode capacitance between the column electrode D2 and the transparent electrode Y2a. This makes it possible to reduce the discharge starting voltage of an address discharge as compared with the case of conventional PDPs and also to widen a margin of the address discharge.

### Third Embodiment

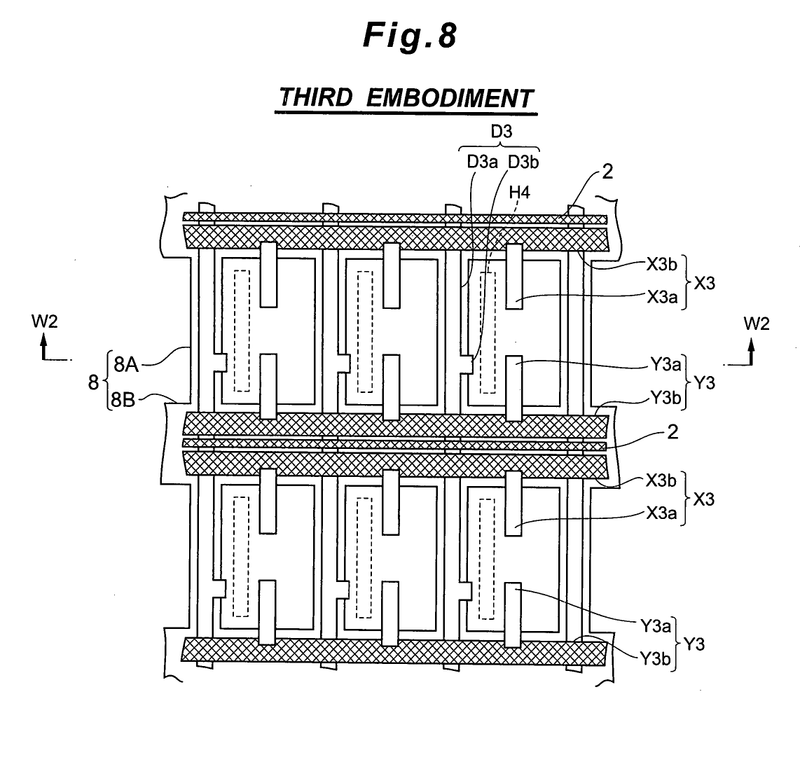

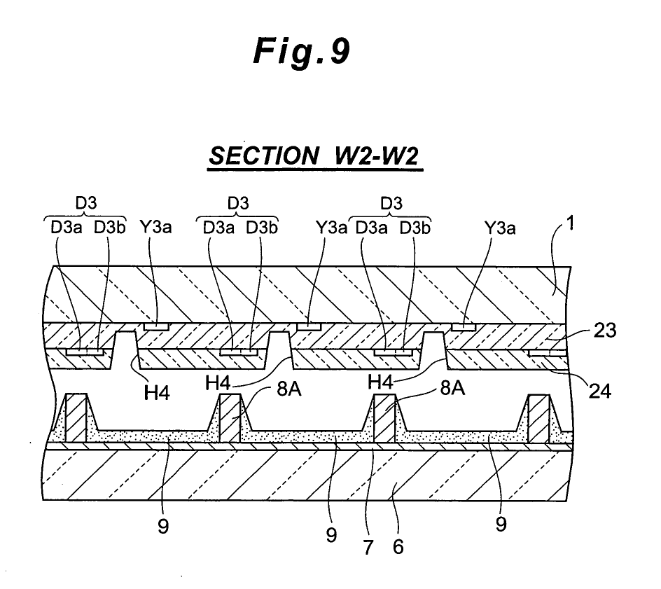

FIGS. 8 and 9 illustrate a third embodiment of the PDP according to the present invention. FIG. 8 is a schematic front view of the PDP in the third embodiment. FIG. 9 is a sectional view taken along the W2-W2 line in FIG. 8.

In FIGS. 8 and 9, row electrodes X3 (Y3) of each row electrode pair (X3, Y3) extending in the row direction on the rear-facing face of the front glass substrate 1 which is the display surface are structured such that transparent electrodes X3a (Y3a) each having a uniform width from its proximal end to its distal end are disposed at regular intervals along a bus electrode X3b (Y3b) extending in the row direction.

Column electrodes D3 are formed on a first dielectric layer 23 covering the row electrode pairs (X3, Y3). Each of the column electrodes D3 is composed of a bar-shaped column-electrode body D3a and column-electrode protrusions D3b. The column-electrode body D3a extends in the column direction in a strip opposite the approximate midpoints between adjacent transparent electrodes X3a (Y3a) of the row electrodes X3 (Y3). Each of the column-electrode protrusions D3b protrudes from a portion of the column-electrode body D3a opposite to the transparent electrode Y3a on the right-hand side thereof in FIG. 8 toward the transparent electrode Y3a.

The column electrodes D3 are covered by a second dielectric layer 24 deposited on the first dielectric layer 23.

Recessed trenches H4 are formed at least in portions of the first dielectric layer 23 and second dielectric layer 24 located between the transparent electrode Y3a of the row electrode Y3 and the leading end of the column-electrode protrusion D3b of the column electrode D3. Each of the recessed trenches H4 extends in the column direction.

In the third embodiment in FIGS. 8 and 9, as in the case of the example described in FIG. 6, the depth of the recessed trench H4 is shorter than the distance from the rear-facing face of the second dielectric layer 24 to the front glass substrate 1. The portion of the front glass substrate 1 corresponding to the recessed trench H4 is thinly covered by the first dielectric layer 23. However, the recessed trench H4 may be formed to a depth extending to the front glass substrate 1 from the rear-facing face of the second dielectric layer 24 such that the rear-facing face of the front glass substrate 1 is exposed at the end of the recessed trench H4.

The structure of other components in the third embodiment is approximately the same as that of the PDP in the first embodiment, and the same components are designated by the same reference numerals.

The PDP in the third embodiment has the recessed trenches H4 each formed between the column-electrode protrusion D3b of the column electrode D3 and the transparent electrode Y3a of the row electrode Y3 between which the address discharge is produced, thus reducing the amount of dielectric intervening between the column-electrode protrusion D3b and the transparent electrode Y3a as compared with the case of conventional PDPs. Hence, as in the case of the PDP in the first embodiment, the interelectrode capacitance between the column electrode D3 and the transparent electrode Y3a is reduced, thereby making it possible to reduce the discharge starting voltage of an address discharge as compared with the case of conventional PDPs and also to widen a margin of the address discharge.

Further, the PDP in the third embodiment has the column electrode D3 provided with the column-electrode protrusions D3b in order for the column electrode D3 to be positioned closer to the transparent electrodes Y3a located on one side of the column electrode D3 (e.g. on the right-hand side in FIG. 8) than the transparent electrodes Y3a located on the other side (e.g. on the left-hand side in FIG. 8). In consequence, an address discharge is easily initiated between the column electrode D3 and the transparent electrode Y3a located on the one side (i.e. on the right-hand side). Further, this makes it possible to further reduce the firing voltage for starting the address discharge.

The terms and description used herein are set forth by way of illustration only and are not meant as limitations. Those skilled in the art will recognize that numerous variations are possible within the spirit and scope of the invention as defined in the following claims.

1. A plasma display panel comprising:
a pair of opposed first and second substrates placed on either side of a discharge space;
a plurality of row electrode pairs each extending in a row direction and arranged at regular intervals in a column direction on the first substrate, and covered by a dielectric layer;
a plurality of column electrodes each extending in the column direction and arranged at regular intervals in the row direction on the first substrate, and covered by a dielectric layer so as to be separated from the row electrode pairs, a discharge being initiated between one of the row electrode pair and the column electrode in the discharge space; and
recessed portions each formed in a portion of the dielectric layers between a part of the column electrode and a part of the row electrode between which the discharge is produced.

2. A plasma display panel according to claim 1, wherein each of the recessed portions has a depth extending to the first substrate from a face of the dielectric layer facing the discharge space.

3. A plasma display panel according to claim 1, wherein each of the recessed portions is formed to a depth shorter than a distance from a face of the dielectric layer facing the discharge space to the first substrate, and a portion of the first substrate corresponding to the recessed portion is covered by the dielectric layer.

4. A plasma display panel according to claim 1, wherein the first substrate is a front substrate located on a display surface of the panel.

5. A plasma display panel according to claim 1, wherein the first substrate is a back substrate located on a rear side of the panel.

6. A plasma display panel according to claim 1, wherein each of the row electrodes constituting each row electrode pair has a row-electrode body extending in the row direction and row-electrode protrusions arranged at regular intervals along the row-electrode body and each protruding from the row-electrode body toward its counterpart in the row electrode pair so that the row-electrode protrusions face each other with a discharge gap in between,
unit light emission areas are formed in positions in the discharge space corresponding to the paired row-electrode protrusions facing each other with the discharge gap in between in each row electrode pair,
each of the column electrodes is located in a position close to a side of each of the unit light emission areas with respect to a center of the unit light emission area, and
each of the recessed portions is formed in the portion of the dielectric layers between the column electrode and a row-electrode protrusion of the row electrode between which the discharge is produced.

7. A plasma display panel according to claim 6, wherein each of the column electrodes has a column-electrode body extending in the column direction and column-electrode protrusions arranged at regular intervals along the column-electrode body and each protruding from the column-electrode body toward the row-electrode protrusion of one of each row electrode pair, and each of the recessed portions is formed in the portion of the dielectric layers between the column-electrode protrusion and the row-electrode protrusion of the row electrode.

8. A plasma display panel according to claim 6, further comprising a partition wall unit provided between the first and second substrates and extending at least in the column direction to provide a partition between the adjacent unit light emission units, wherein each of the column electrodes extends in a strip opposite to a portion of the partition wall unit extending in the column direction.
